(19) United States
(12) Patent Application Publication
(10) Pub. No.: US 2020/0256430 A1
(43) Pub. Date: Aug. 13, 2020

(54) ANGLE ACCESSORY GEARBOX FOR GAS TURBINE ENGINE

(71) Applicant: United Technologies Corporation, Farmington, CT (US)

(72) Inventors: Hung Duong, Unionville, CT (US); Marc J. Muldoon, Marlborough, CT (US); Gabriel L. Suciu, Glastonbury, CT (US); Joseph H. Polly, Tolland, CT (US); Nicholas D. Leque, Vernon, CT (US)

(21) Appl. No.: 16/274,360

(22) Filed: Feb. 13, 2019

(51) Int. Cl. F16H 1/22; F02C 7/32

(52) U.S. Cl. CPC F16H 1/222; F05D 2260/4031; F02C 7/32

(57) ABSTRACT

A gas turbine engine includes a low speed input shaft connected to a low speed tower shaft, in turn connected to a lower speed spool and a high speed input connected to a high speed tower shaft, in turn connected to a higher speed spool. The low speed input shaft is connected to drive a first plurality of accessories. The high speed input shaft is connected to drive a second plurality of accessories. The high speed tower shaft and the low speed tower shaft are coaxial and rotate about a common axis. An angle drive is provided into the low speed input shaft and the high speed input shaft, respectively.

### BACKGROUND

This application relates to an accessory gearbox for a gas turbine engine with an angle input.

Gas turbine engines are known and typically include a fan delivering air into a bypass duct as propulsion air and into a compressor section. Air is compressed in the compressor section and delivered into a combustor where it is mixed with fuel and ignited. Products of this combustion pass downstream over turbine rotors driving them to rotate.

The turbine rotors drive a number of accessories associated with the gas turbine engine, or perhaps an associated aircraft through a tower shaft.

It is known for a gas turbine engine to have two spools, with a first rotating at lower speeds and lower pressures, and a second rotating at higher speeds and higher pressures. It has been proposed to drive accessories from tower shafts driven by each of the two spools.

As gas turbine engines become smaller, packaging for the gearboxes that transmit drive from the tower shafts to the various auxiliary systems becomes a challenge.

### SUMMARY

In a featured embodiment, a gas turbine engine includes a low speed input shaft connected to a low speed tower shaft, in turn connected to a lower speed spool and a high speed input connected to a high speed tower shaft, in turn connected to a higher speed spool. The low speed input shaft is connected to drive a first plurality of accessories. The high speed input shaft is connected to drive a second plurality of accessories. The high speed tower shaft and the low speed tower shaft are coaxial and rotate about a common axis. An angle drive is provided into the low speed input shaft and the high speed input shaft, respectively.

In another embodiment according to the previous embodiment, the first plurality of accessories rotating about a first set of rotational axes, which are parallel to each other but spaced along an axial input direction and are perpendicular to a first plane. The second plurality of accessories rotate about a second set of rotational axes, which are parallel to each other and spaced along an axial input direction and perpendicular to a second plane. The first and second planes extend in opposed directions away from a drive input axis of the high speed input shaft and the low speed input shaft.

In another embodiment according to any of the previous embodiments, the low speed input shaft and the high speed input shaft are concentric.

In another embodiment according to any of the previous embodiments, the high speed input shaft is hollow and the low speed input shaft is positioned within the high speed input shaft.

In another embodiment according to any of the previous embodiments, the high speed tower shaft is received within the low speed tower shaft.

In another embodiment according to any of the previous embodiments, each of the low speed and high speed tower shafts drive a bevel gear to in turn drive a bevel gear connected to the low speed input shaft and low speed output shaft.

In another embodiment according to any of the previous embodiments, a drive axis of the low speed tower shaft and the high speed tower shaft is at a non-perpendicular and non-parallel angle relative to a drive axis of the low speed input shaft and the high speed input shaft.

In another embodiment according to any of the previous embodiments, the angle is between 5° and 85°.

In another embodiment according to any of the previous embodiments, each of the low speed and high speed input shafts drive a bevel gear and, in turn, the bevel gears drive gears to drive the first plurality of accessories and the second plurality of accessories, respectively.

In another embodiment according to any of the previous embodiments, each of the bevel gears drive a gear, which is engaged to drive another gear, and the another gear engaged to drive a third gear.

In another embodiment according to any of the previous embodiments, an input gear for the low speed input shaft drives a first shaft with a plurality of bevel gears, with each of the bevel gears driving an associated drive gear for one of the first plurality of accessories. An input gear for the higher speed shaft drives a second shaft with a plurality of bevel gears which each bevel gears driving an associated to drive the drive gears associated for one of the second plurality of accessories.

In another embodiment according to any of the previous embodiments, an input gear for the low speed input shaft drives a first shaft with a plurality of bevel gears. Each of the bevel gears drive an associated drive gear for one of the first plurality of accessories. An input gear for the higher speed shaft drives a second shaft with a plurality of bevel gears which each bevel gears driving an associated to drive the drive gears associated for one of the second plurality of accessories.

In another embodiment according to any of the previous embodiments, the high speed tower shaft is received within the low speed tower shaft.

In another embodiment according to any of the previous embodiments, each of the low speed and high speed tower shafts drive a bevel gear to in turn drive a bevel gear connected to the low speed input shaft and low speed output shaft.

In another embodiment according to any of the previous embodiments, a drive axis of the low speed tower shaft and the high speed tower shaft is at a non-perpendicular and non-parallel angle relative to a drive axis of the low speed input shaft and the high speed input shaft.

In another embodiment according to any of the previous embodiments, a drive axis of the low speed tower shaft and the high speed tower shaft is at a non-perpendicular and non-parallel angle relative to a drive axis of the low speed input shaft and the high speed input shaft.

In another embodiment according to any of the previous embodiments, each of the low speed and high speed input shafts drives a bevel gear and, in turn, the bevel gears drive gears to drive the first plurality of accessories and the second plurality of accessories, respectively.

In another embodiment according to any of the previous embodiments, each of the bevel gears drive a gear, which is engaged to drive another gear, and the another gear engaged to drive a third gear.

In another embodiment according to any of the previous embodiments, an input gear for the low speed input shaft drives a first low shaft with a plurality of bevel gears. Each of the bevel gears drive an associated drive gear for one of the first plurality of accessories. An input gear for the higher speed shaft drives a second high shaft with a plurality of bevel gears which each bevel gears driving an associated to drive the drive gears associated for one of the second plurality of accessories.

In another embodiment according to any of the previous embodiments, an input gear for the low speed input shaft drives a first low shaft with a plurality of bevel gears. Each of the bevel gears drive an associated drive gear for one of the first plurality of accessories. An input gear for the higher speed shaft drive a second high shaft with a plurality of bevel gears which each bevel gears driving an associated to drive the drive gears associated for one of the second plurality of accessories.

These and other features may be best understood from the following drawings and specification.

### BRIEF DESCRIPTION OF THE DRAWINGS

FIG. 1 schematically shows a gas turbine engine.

FIG. 2A shows an accessory gearbox.

FIG. 2B shows a feature of an angle drive.

FIG. 2C shows a geometric relationship.

FIG. 3A shows drive details.

FIG. 3B schematically shows geometric relationships.

FIG. 3C shows a detail of an input.

FIG. 3D shows further details of the input.

FIG. 4 shows an alternative drive.

### DETAILED DESCRIPTION

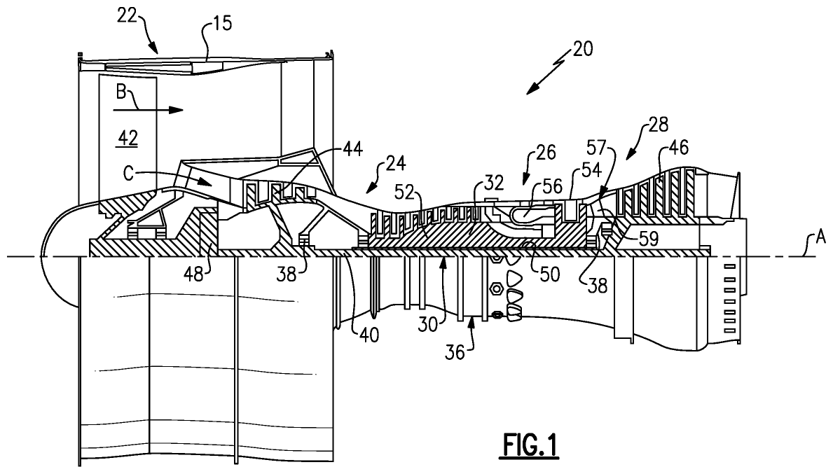

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFCT’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

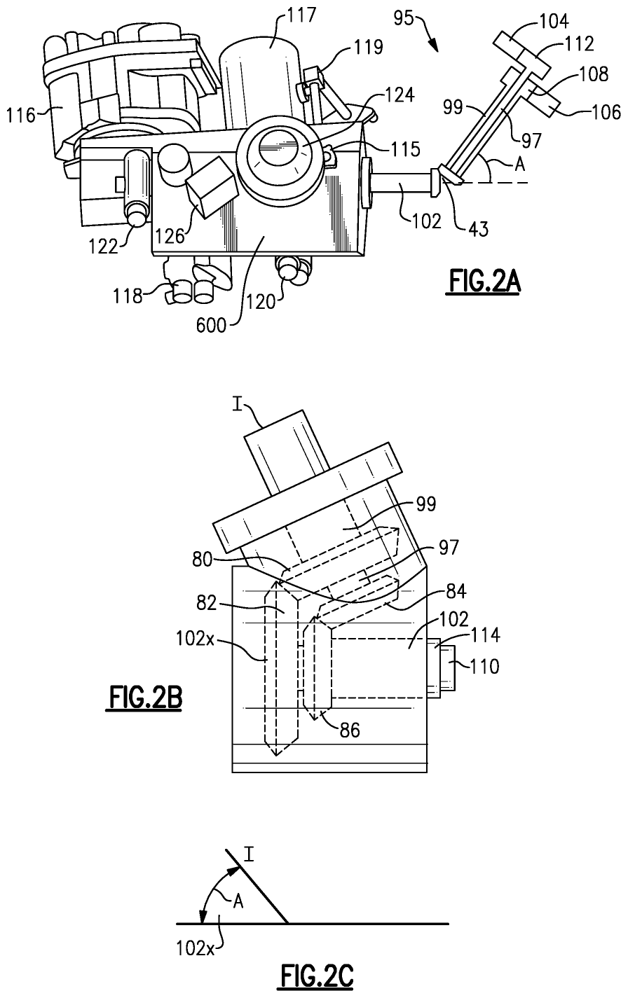

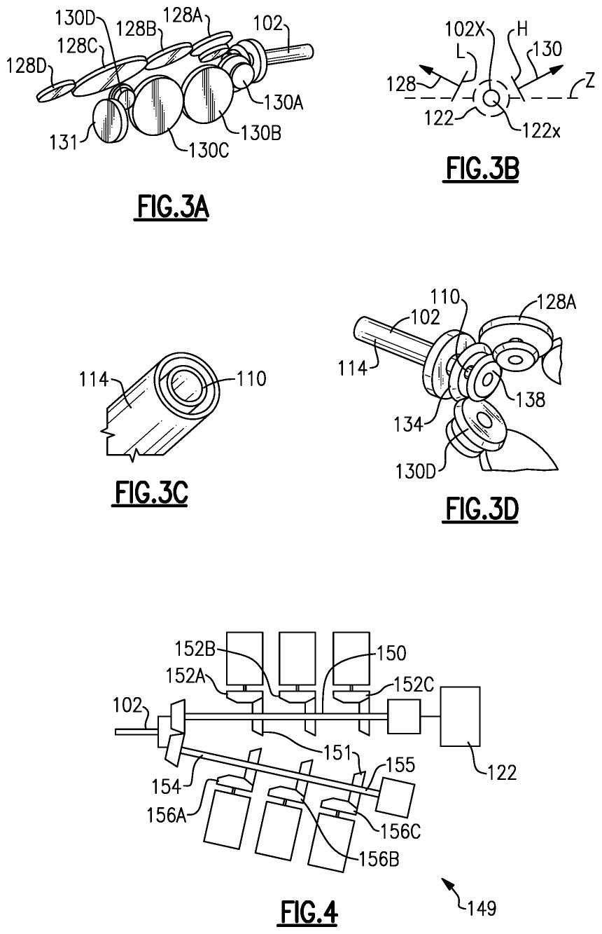

An accessory gearbox 95 and drive system is illustrated in FIG. 2A. An input shaft 102 includes concentric high and low speed input shafts 110/114 (see FIGS. 2B and 3C). As can be appreciated, the low speed input shaft 114 is driven by a low speed tower shaft 97 which is driven through a gear 112, which is driven through a gear 104 (shown schematically) which will rotate with the low speed spool. The gear 110 drives a high speed tower shaft 99. The high speed tower shaft 99 includes a gear 108 which is driven by a gear 106 which rotates with the high speed spool (again shown schematically). As shown, the drive shafts 99 and 97 extend in at an angle A (FIG. 2C) relative to a rotational or drive axis 102X of the input shaft 102. The angle A is not 90 or 180 degrees. That is, the combined shafts 97/99 and the input shaft 102 are not perpendicular or parallel.

As will be explained below, the accessories may include a generator 116, a variable transmission 117, an air turbine starter 124, a de-oiler 115, an oil pump 120, a hydraulic pump 118, and a fuel pump 126. Also, an intercooled cooling air boost compressor 122 is illustrated. In one embodiment, generator 116, transmission 117, a rotator tool 119, the oil pump 120, and the hydraulic pump 118 may all be driven by the low speed tower shaft 97. The de-oiler 115, air turbine starter 124, fuel pump 126, and the boost compressor 122 and a permanent magnet alternator (not shown) may be driven by the high speed tower shaft 99.

FIG. 2B shows the angle drive in more detail. The low speed tower shaft 97 drives a gear 84 which is a bevel gear and engages a gear 86 to drive the low speed input shaft 114. The high speed tower shaft 99 drives the bevel gear 80 which is engaged to and drives a bevel gear 82 to in turn drive the high speed input shaft 110.

Notably, while the low speed input shaft 114 is concentric with and received within the high speed input shaft 110, the opposite is true of the shafts 97 and 99 in the angle drive input 95. Here the low speed tower shaft 97 is outward of the high speed tower shaft 99. In other embodiments, the high speed input shaft 110 is concentric with and received within the low speed input shaft 114, and/or the high speed tower shaft 99 is outward of the low speed tower shaft 97.

A rotation axis I of the shafts 97 and 99 is shown at the angle A in FIG. 2C relative to a drive axis 102x of the shafts 114 and 110.

In embodiment, the angle A may be between 5° and 85°.

Notably, this disclosure has particular application for an accessory gearbox in a two spool engine, and wherein the low speed input shaft is driven by a low spool which also drives a fan through a gear reduction. Such low speed spools can have a wide speed excursion, and say on the order of 80%.

FIG. 3A shows the input shaft 102. The shaft high speed input shaft 110 (FIGS. 2B and 3C) drives gears 130A, 130B, 130C, and 130D. These gears all, in turn, drive the accessory such as shown in FIG. 2A. A bevel gear at the end of the gear 130D drives another gear 131, which is the drive gear for the boost compressor 122.

The low speed input shaft 114 (FIGS. 2B and 3C) drives a plurality of gears 128A, 128B, 128C, and 128D. These gears then drive the several low speed driven auxiliary systems.

As can be appreciated from FIG. 3B, the gearbox could be said to be a V gearbox. The V gearbox is defined by two planes L and H. Gearbox plane L includes a plurality of rotational axes 128 of the gears 128A-128D. Plane H is the same, but with the rotational axes 130 of the gears 130A-130D. The axes 128A-128D extend perpendicularly through the plane L and are parallel to each other. The same is true for the axes 130A-130D in claim H. The planes L, H can be seen to define angles relative to a plane Z, which bisects the rotational axis 102X of the shafts 110 and 114. As can be appreciated, the angles defined by the planes L, H extend in opposed directions relative to the axis 102X. As is also shown in this figure, the boost compressor 122 rotates about a drive axis 122X. The boost compressor 122 rotates about a drive axis 122X, which is concentric with the axis 102X.

All of this is received within a single gearbox 600 (see FIG. 2A). While the illustrated embodiments have the axes concentric, the axes need not be concentric, or even parallel.

FIG. 3C shows the high speed input shaft 110 packaged within the low speed input shaft 114.

FIG. 3D shows a gear 138, which is driven by the shaft 110 to, in turn, engage and drive the gear 128A, and then the other gears as shown in FIG. 3A. Similarly, a bevel gear 134 driven by shaft 114 drives gear 130D and, in turn, the other gears.

FIG. 4 shows an alternative embodiment 149. In embodiment 149, the input 102 drives a first shaft 150 extending along an axis and driving a plurality of bevel gears 151, which engage and drive a plurality of gears 152A-152C. In a sense, this arrangement replaces the engaged gears 130A-130D. Similarly, a shaft 154 drives bevel gears 155, which engage and drive a plurality of gears 156A-156C. In this arrangement, the boost compressor 122 is shown driven at the end of the shaft 150. Although the input 102 is not shown here it may be structured as in FIG. 3D.

In combination, the V transmission and the packaging of the boost compressor 122 such that it is driven on an axis which is distinct from the axes 128/130 in planes L, H provides more compact packaging, while adding the additional boost compressor 122.

A gas turbine engine under this disclosure has a low speed input shaft connected to a low speed tower shaft, in turn connected to a lower speed spool and a high speed input connected to a high speed tower shaft, in turn connected to a higher speed spool, the low speed input shaft being connected to drive a first plurality of accessories. The high speed input shaft is connected to drive a second plurality of accessories. The first plurality of accessories rotate about a first set of rotational axes, which are parallel to each other but spaced along an axial input direction and are perpendicular to a first plane. The second plurality of accessories rotate about a second set of rotational axes, which are parallel to each other and spaced along an axial input direction and perpendicular to a second plane. The first and second planes extend in opposed directions away from a drive input axis of the high speed input shaft and the low speed input shaft. The high speed tower shaft and the low speed tower shaft are coaxial and rotating about a common axis, and provide an angle drive into the low speed input shaft and the high speed input shaft, respectively.

Although an embodiment of this invention has been disclosed, a worker of ordinary skill in this art would recognize that certain modifications would come within the scope of this disclosure. For that reason, the following claims should be studied to determine the true scope and content of this disclosure.

1. A gas turbine engine comprising:
a low speed input shaft connected to a low speed tower shaft, in turn connected to a lower speed spool and a high speed input connected to a high speed tower shaft, in turn connected to a higher speed spool, said low speed input shaft being connected to drive a first plurality of accessories, and said high speed input shaft connected to drive a second plurality of accessories; and
said high speed tower shaft and said low speed tower shaft being coaxial and rotating about a common axis, and providing an angle drive into said low speed input shaft and said high speed input shaft, respectively.

2. The gas turbine engine as set forth in claim 1, wherein said first plurality of accessories rotating about a first set of rotational axes, which are parallel to each other but spaced along an axial input direction and are perpendicular to a first plane and said second plurality of accessories rotating about a second set of rotational axes, which are parallel to each other and spaced along an axial input direction and perpendicular to a second plane, said first and second planes extending in opposed directions away from a drive input axis of said high speed input shaft and said low speed input shaft

3. The gas turbine engine as set forth in claim 2, wherein said low speed input shaft and said high speed input shaft are concentric.

4. The gas turbine engine as set forth in claim 3, wherein said high speed input shaft is hollow and said low speed input shaft is positioned within said high speed input shaft.

5. The gas turbine engine as set forth in claim 4, wherein said high speed tower shaft is received within said low speed tower shaft.

6. The gas turbine engine as set forth in claim 5, wherein each of said low speed and high speed tower shafts driving a bevel gear to in turn drive a bevel gear connected to said low speed input shaft and low speed output shaft.

7. The gas turbine engine as set forth in claim 6, wherein a drive axis of said low speed tower shaft and said high speed tower shaft is at a non-perpendicular and non-parallel angle relative to a drive axis of said low speed input shaft and said high speed input shaft.

8. The gas turbine engine as set forth in claim 7, wherein said angle is between 5° and 85°.

9. The gas turbine engine as set forth in claim 6, wherein each of said low speed and high speed input shafts drives a bevel gear and, in turn, said bevel gears drive gears to drive said first plurality of accessories and said second plurality of accessories, respectively.

10. The gas turbine engine as set forth in claim 9, wherein each of said bevel gears drive a gear, which is engaged to drive another gear, and said another gear engaged to drive a third gear.

11. The gas turbine engine as set forth in claim 10, wherein an input gear for said low speed input shaft driving a first shaft with a plurality of bevel gears, with each of said bevel gears driving an associated drive gear for one of said first plurality of accessories, and an input gear for said higher speed shaft driving a second shaft with a plurality of bevel gears which each bevel gears driving an associated to drive said drive gears associated for one of said second plurality of accessories.

12. The gas turbine engine as set forth in claim 6, wherein an input gear for said low speed input shaft driving a first shaft with a plurality of bevel gears, with each of said bevel gears driving an associated drive gear for one of said first plurality of accessories, and an input gear for said higher speed shaft driving a second shaft with a plurality of bevel gears which each bevel gears driving an associated to drive said drive gears associated for one of said second plurality of accessories.

13. The gas turbine engine as set forth in claim 1, wherein said high speed tower shaft is received within said low speed tower shaft.

14. The gas turbine engine as set forth in claim 13, wherein each of said low speed and high speed tower shafts driving a bevel gear to in turn drive a bevel gear connected to said low speed input shaft and low speed output shaft.

15. The gas turbine engine as set forth in claim 14, wherein a drive axis of said low speed tower shaft and said high speed tower shaft is at a non-perpendicular and non-parallel angle relative to a drive axis of said low speed input shaft and said high speed input shaft.

16. The gas turbine engine as set forth in claim 1, wherein a drive axis of said low speed tower shaft and said high speed tower shaft is at a non-perpendicular and non-parallel angle relative to a drive axis of said low speed input shaft and said high speed input shaft.

17. The gas turbine engine as set forth in claim 1, wherein each of said low speed and high speed input shafts drives a bevel gear and, in turn, said bevel gears drive gears to drive said first plurality of accessories and said second plurality of accessories, respectively.

18. The gas turbine engine as set forth in claim 17, wherein each of said bevel gears drive a gear, which is engaged to drive another gear, and said another gear engaged to drive a third gear.

19. The gas turbine engine as set forth in claim 18, wherein an input gear for said low speed input shaft driving a first low shaft with a plurality of bevel gears, with each of said bevel gears driving an associated drive gear for one of said first plurality of accessories, and an input gear for said higher speed shaft driving a second high shaft with a plurality of bevel gears which each bevel gears driving an associated to drive said drive gears associated for one of said second plurality of accessories.

20. The gas turbine engine as set forth in claim 1, wherein an input gear for said low speed input shaft driving a first low shaft with a plurality of bevel gears, with each of said bevel gears driving an associated drive gear for one of said first plurality of accessories, and an input gear for said higher speed shaft driving a second high shaft with a plurality of bevel gears which each bevel gears driving an associated to drive said drive gears associated for one of said second plurality of accessories.
